(19) United States
(12) Patent Application Publication
(10) Pub. No.: US 2017/0328471 A1
(43) Pub. Date: Nov. 16, 2017

(54) TWO-PIECE PISTON RING

(71) Applicant: FEDERAL-MOGUL BURSCHEID GMBH, BURSCHEID (DE)

(72) Inventors: JORN PROPPER, LEVERKUSEN (DE); FABIAN RUCH, LEVERKUSEN (DE)

(21) Appl. No.: 15/529,232

(22) PCT Filed: Sep. 15, 2015
(86) PCT No.: PCT/EP2015/071006

§ 371 Date: May 24, 2017

(30) Foreign Application Priority Data
Nov. 25, 2014 (DE) 102014223989.3

(51) Int. Cl. F16J 9/06

(52) U.S. Cl. CPC F16J 9/06

(57) ABSTRACT

A piston ring has an annular base body 2, which is preferably open at a joint, with a U-shaped cross section, the open side of which faces inwards in the radial direction. A ring spring 4 is provided which runs in a meandering manner in the axial direction, and which pretensions the base body 2 outwards in the radial direction. In one section of the ring spring 4, which is located inside the base body, meandering loops 5 bear alternately against the shanks 3 of the U-shaped cross section. In one section of the ring spring 4, which protrudes out of the base body 2, meandering loops 6 bear alternately against the radially inwardly facing edges of the shanks 3 of the U-shaped cross section.

The invention relates to an improved piston ring, particularly a compression ring, with a two-part construction.

One of the tasks of piston rings is the sealing of the combustion chamber with respect to the crankshaft housing. Rings of this type are therefore also termed compression or top rings. The gas quantity which can pass the uppermost ring, ultimately determines the quantity of gas which can make it outside through the engine as so-called blow-by. It is appropriate here, by means of a best possible seal to keep the compression of the engine as high as possible, in order to optimize the efficiency thereof. By reducing blow-by losses, the oil dilution caused thereby can be minimized. It is fundamentally desired to prevent blow-by losses as much as possible.

However, this is only possible by means of a best possible seal between the cylinder wall or cylinder lining and piston. In practice, it is in contrast with this however, that at the same time a lowest possible friction is to be achieved between the piston rings and cylinder interior. The pressure of the piston rings on the cylinder running surface therefore cannot be increased in an unlimited manner, as otherwise the friction would get too high. The piston ring must act in a sealing manner both on the ring flank and on the cylinder running surface.

Rectangular or trapezoidal rings are used predominantly in the uppermost piston ring groove. These rings obtain their pressure on the cylinder running surface from the pretension of the base body thereof. However, due to a corresponding material thickness, in order to guarantee this tension, the ring can follow irregularities in the cylinder running surface less well.

Although piston rings with a smaller material thickness can follow irregularities better, the piston rings also have a lower tension and have more of a tendency to ring breaks than thicker rings owing to the reduced thicknesses. The latter is true in particular for compression rings with an essentially U-shaped cross section, as here relatively thin shanks are present, which on the one hand bear against the groove flank and on the other hand are exposed to the combustion pressure during the working cycle. These loads may give rise to a bending moment which may lead to a break.

Consequently, it is the object of the present invention to provide a two-pare piston ring with reduced oil consumption and at least identical resistance to loads which may lead to ring breakage. The object furthermore also consists in improving the oil scraping effect for at most equal or even reduced frictional losses. A piston ring, particularly a compression ring, with improved form matching capability (higher elasticity in the radial direction) is suggested.

According to one aspect of the invention, a piston ring, particularly a compression ring, is provided, comprising:

an annular base body, which is open at a joint, with a U-shaped cross section, the open side of which faces inwards in the radial direction;

a ring spring running in a meandering manner in the axial direction, which pretensions the base body outwards in the radial direction;

wherein in one section of the ring spring, which is located inside the base body, meandering loops bear alternately against the shanks of the U-shaped cross section; and

wherein in one section of the Ring spring, which protrudes out of the base body, meandering loops bear alternately against the radially inwardly facing edges of the shanks of the U-shaped cross section.

The object is achieved inter alia by removing material in the ring interior compared to a solid material ring. As the running surface and flanks or the respective surfaces thereof are required furthermore, this leads to a U-shaped cross section. The ring becomes more flexible in the radial direction by using a U-shaped base body. The U-shaped cross section in turn reduces the required tangential force and weakens the upper strongly pressure-loaded flank. Due to the reduced rigidity, the radial pressure, which arises from the ring geometry, is also reduced for the same dimensions. These disadvantages are compensated by the suggested use of a spring.

For identical tangential force and higher form matching capability, the piston ring according to the invention can better follow more pronounced cylinder distortions and ensure greater leak-tightness at the running surface. As the wall thickness or the bearing area remains unchanged at the two ring flanks, sealing results furthermore at the flanks. A comparable form matching capability would only be possible with conventional Solid material rings by means of tangential force increase, which would in turn lead to high frictional losses.

Due to the high pressure on the ring flanks and the contact points with the groove flanks at the outer points on the piston ring, a bending moment may arise during engine operation, which is captured in the suggested ring by means of a meandering spring, the height of which in the interior of the U-shaped base body or axially between the shanks thereof prevents bending of the thinner shank sections. The meandering spring therefore supports the shanks of the U-shaped base body with respect loads in the axial direction.

As a whole, a piston ring with reduced oil consumption/improved oil scraping effect therefore results, with at most equal or even reduced frictional losses with simultaneously achieved stability with respect to ring breakage.

According to an embodiment, the base body and/or the interior of the U-shaped cross section have a rectangular shape. As a result, already known production methods for the piston ring can be applied. Alternatively, however, novel methods such as stamping and bending can also be used.

According to an embodiment, the ring spring has a rectangular, trapezoidal or wave-shaped meandering shape.

### SHORT DESCRIPTION OF THE FIGURES

FIG. 1 is a cross-sectional view of a conventional, one-piece piston ring with U profile;

FIG. 2 is a plan view of an embodiment of a two-part piston ring according to the invention;

FIG. 3 is a cross-sectional view through a further embodiment of a two-part piston ring according to the invention; and

FIGS. 4 and 5 show meandering profiles, which can be used in embodiments of the piston ring according to the invention.

### DETAILED DESCRIPTION

FIG. 1 shows a cross section through a conventional one-piece compression piston ring having a base body 2 with a U-shaped cross section. During the working cycle of the associated engine, the lower flank 3 of the ring bears against the ring groove (not shown). The combustion pressure acts on the upper flank 3 during the working cycle of the engine, indicated by arrows. As the flank has a substantially smaller wall thickness than rectangular rings for example, owing to the U profile, a bending of the flank may result, as illustrated here.

Due to high peak loading and/or due to fatigue owing to constant bending during operation, the ring may ultimately break, for example in the region of the transition into the shank of the U profile.

Also, the one-piece U profile piston ring shown has a lower radial pressure compared to a rectangular ring with otherwise identical dimensions. The pressure on the cylinder running surface is therefore lower.

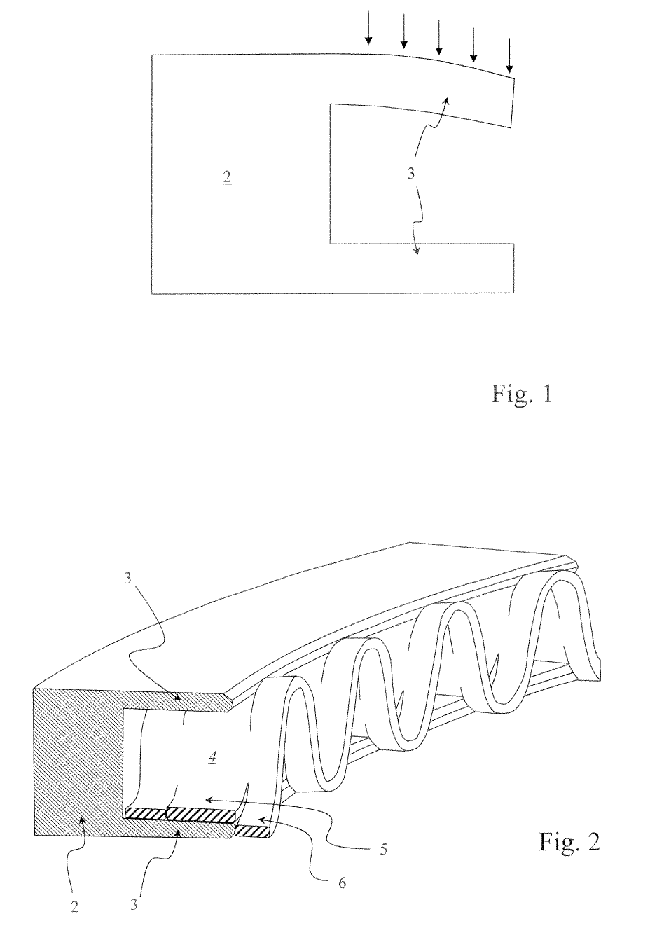

To solve these problems, the invention therefore suggests a two-part piston ring. FIG. 2 shows an embodiment of such a piston ring. The piston ring 1 has a base body 2 with U-shaped cross section. In the embodiment shown, the radially inwardly facing edges of the shanks of the U cross section are bevelled. Alternatively, right-angled and also rounded edges or combinations thereof are likewise possible.

A meandering ring spring 4 is accommodated in the inferior of the U profile. In the section of the ring spring 4, which is accommodated inside the base body 2, that is to say is located between the shanks of the U profile, the meandering loops 5 bear alternately on the upper or lower inner flank of the U profile. In the section of the ring spring 4, which protrudes out of the base body 2, the meandering loops 6 bear alternately against the radially inwardly facing edges of the shanks 3 of the U-shaped cross section.

As a result, the two-part piston ring has two advantageous properties compared to a one-part U-shaped ring. On the one hand, the radial pressure is increased by the ring spring 4, which can press the base body 2 outwards by bearing against the radial internal edges of the shanks. On the other hand, the inner sections of the ring spring 4 support the shanks or flanks 3 with respect to pressure loads in the axial direction. Ring breakage can therefore be prevented.

Slots are located at the respective meandering loops, which separate the inner meandering loops 5 from the outer meandering loops 6. The slots are for example located in the respective outer third with respect to the height. By contrast, the ring spring 4 is in one piece in the central third. Other divisions are likewise possible, as long as a sufficiently large area in the centre remains integral, in order to ensure the stability of the spring.

likewise, it is merely optional, as illustrated to use a symmetrical spring, which also has meandering loops which are separated by slots in the inner area. This may also be desirable for reasons of simplified production of the spring, even if the inner loops at the edge are then functionless.

Due to the relatively open construction of the spring, the piston ring can also preferably be used as compression or top ring. The combustion pressure can penetrate at the open points in a relatively unhindered manner to the inner base surface of the base body and thus press the piston ring onto the cylinder running surface. This is an advantage compared to more solid elements of two-part piston rings, in which gas passage of this type is not possible.

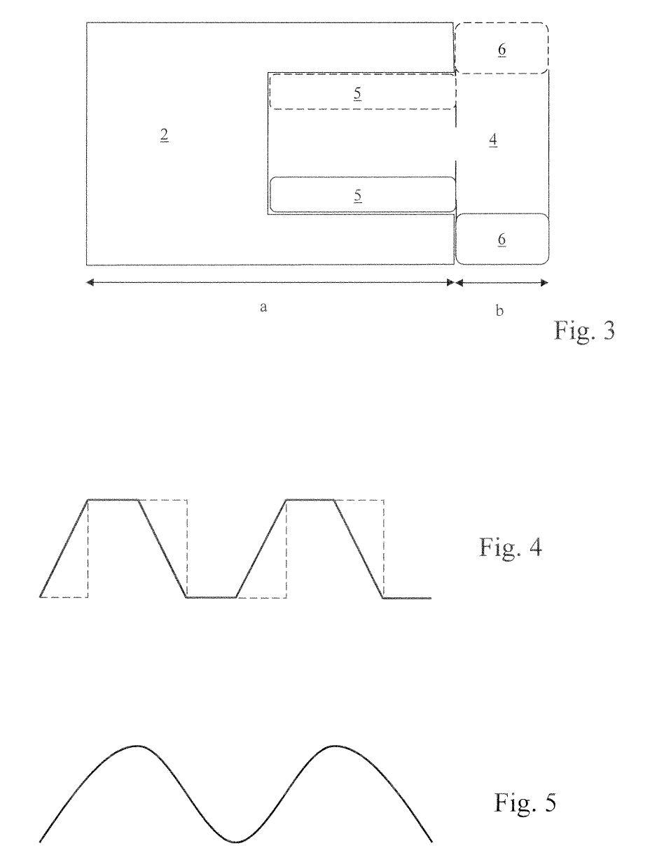

FIG. 3 shows an alternative embodiment of the piston ring in cross section. Here, an asymmetrical ring spring 4 is used, which exclusively has a (wider) inner area with meandering loops 5 and a (narrower) outer area with meandering loops 6. In the case of the cross section shown, the in each case lower meandering loops bear against the lower shank of the U profile. The loops located therebehind in the circumferential direction, when then bear against the upper shank, are shown dashed.

FIGS. 4 and 5 show alternatives for the meandering shape of the ring spring. Trapezoidal loops (solid) and rectangular loops (dashed) are shown in FIG. 4. In both cases, it is true that as a result, the bearing points on the U profile, which are only punctiform or linear in wave-shaped meandering runs, are replaced by flatter contact faces. That may be advantageous in order to introduce the forces in a more evenly distributed manner. In addition, the piston ring can be better reinforced against bending moments by means of steeper to vertical runs of the spring.

FIG. 5 shows a wave-shaped meandering run. This can also be adjusted with regards to the supporting effect, by adjusting the steepness and/or number of loops.

1. A piston ring (1), comprising:
an annular base body (2), which is preferably open at a joint, with a U-shaped cross section, the open side of which faces inwards in the radial direction;
a ring spring (4) running in a meandering manner in the axial direction, which pretensions the base body (2) outwards in the radial direction;
wherein in one section of the ring spring (4), which is located inside the base body, meandering loops (5) bear alternately against the shanks (3) of the U-shaped cross section; and
wherein in one section of the ring spring (4), which protrudes out of the base body (2), meandering loops (6) bear alternately against the radially inwardly facing edges of the shanks (3) of the U-shaped cross section.

2. The piston ring (1) according to claim 1, wherein the base body (2) and/or the interior of the U-shaped cross section have a rectangular shape.

3. The piston ring (1) according to one of the preceding claims, wherein the ring spring (4) has a rectangular, trapezoidal or wave-shaped meandering shape.

4. The piston ring (1) according to one of the preceding claims, wherein the piston ring (1) is a compression piston ring.
